(19) United States
(12) Patent Application Publication
(10) Pub. No.: US 2008/0100642 A1
(43) Pub. Date: May 1, 2008

(54) USER DEFINABLE ASPECT RATIOS FOR IMAGE REGIONS

(75) Inventors: Melissa Betancourt, Miami, FL (US); Rodrigo J. Pastrana, Delray Beach, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/555,125

(22) Filed: Oct. 31, 2006

(51) Int. Cl. G09G 5/00

(52) U.S. Cl. 345/663; 345/689

(57) ABSTRACT

The present invention discloses a method for adjusting an image displayed in a graphical user interface. The method can include a step of identifying an original region that is a visible rectangular region containing a displayed digital image. A user defined aspect ratio can be established using an aspect ration input control. An area of the original region can be changed to create an adjusted region. The adjusted region can automatically have the user defined aspect ratio. An image manipulation operation can be performed on the displayed digital image so that a manipulated version of the image is displayed within the adjusted region. Image manipulation operations can include resizing, clipping, cropping, and applying a special effect to the image.

### BACKGROUND

1. Field of the Invention

The present invention relates to the field of software based image manipulation and, more particularly, to user definable aspect ratios for image regions.

2. Description of the Related Art

Many computer programs permit users to manipulate displayed images using a user definable region. The region can overlay an image and can appear with edges shown as a dotted line, where the region is filled in a semi-transparent manner so that the image underneath is still visible. After the region is defined, an image manipulation operation can be performed. Common image manipulation operations include image resizing, image cropping, image clipping, applying special effects, and the like. Special effects can change a characteristic of the image. For example, common special effects include red-eye reduction, slimming, morphing, sharpening, pixilating, adjusting a contrast, adjusting a hue, and the like.

FIG. 1 illustrates conventional mechanisms for defining regions for image manipulation purposes. Graphical User Interfaces (GUIs) 110 and 120 together show a typical image resizing operation. In GUI 110, an original rectangular region 112 is displayed, which has manipulation handles at its corners and/or sides. When one of these handles is selected, such as endpoint 114, a user is able to resize the region 112 by moving pointer 118 to a different location, such as a location associated with endpoint. 124. A relative position of a reference point 116 and a corresponding point 126 remains fixed. Establishing new endpoint 124 results in a modified rectangular region 122. The image in region 122 is typically either resized or clipped to fit the dimensions of modified region 122.

GUIs 130 and 140 together show a typical pointer based method for defining a region 142. In GUI 130, a pointer 138 can be positioned and a reference point 136 can be established, usually by pressing a mouse button. This mouse button stays pressed as the pointer (138) is dragged to a new position, as shown by pointer 148, where the button is released. Releasing the button defines endpoint 144. A rectangular region 142 is created having one corner of reference point 146, which corresponds to reference point 136, and a diagonally opposing corner of endpoint 144. After region 142 is defined, an image manipulation operation can be performed for that region 142.

GUIs 150 and 160 together show a typical coordinate based method for defining a region 162. In GUI 150, a user provides X 151 and Y 153 coordinates for a reference point 156. X and Y coordinates can also be provided for endpoint 154 that corresponds to endpoint 164. Instead of providing numeric coordinates for endpoint 154, a width 155 and height 157 can be provided that serves an equivalent purpose. After region 162 is defined, an image manipulation operation can be performed for that region 162.

None of the above region defining mechanisms permits a user to specify a desired aspect ratio. Whenever a user wants to maintain a particular ratio, he/she is currently forced to calculate desired width and height values (or endpoint coordinates) and enter them into a coordinate based interface, such as interface 150. Otherwise, the user can use a pointing based image manipulation technique to repetitively approximate a desired ratio by dynamically defining a region with a pointer, as shown by GUIs 110-140. Both of these methods can be extremely cumbersome and frustrating to a user.

A few software programs exist that permit a current image to be automatically scaled to a defined target image frame. For example, numerous photo ordering applications can permit a user to import digital photographs into predefined 4″×6″ or 5″×7″ frames. These programs do not allow users to dynamically manipulate images in accordance with user established ratios.

Weaknesses with existing image manipulation techniques can be emphasized through a collage example. In the example, a user can desire to create a collage of image items acquired from digital photos. An original ratio of these digital photos can be 6:4. The user can desire each collage item to have a ratio of 5:3. Further, the user may want to vary the sizes of the collage images, while the 5:3 aspect ratio is maintained. Creating this collage can be an extremely tedious and time consuming operation using conventional image manipulation tools.

### SUMMARY OF THE INVENTION

The present invention discloses a method for adjusting an image displayed in a graphical user interface. The method can include a step of identifying an original region that is a visible rectangular region containing a displayed digital image. A user defined aspect ratio can be established using an aspect ratio input control. An area of the original region can be changed to create an adjusted region. The adjusted region can automatically have the user defined aspect ratio. An image manipulation operation can be performed on the displayed digital image so that a manipulated version of the image is displayed within the adjusted region. Image manipulation operations can include resizing, clipping, cropping, and applying a special effect to the image.

Another configuration of the present invention can include a graphical user interface (GUI) that includes an aspect ratio input control and an image region. The aspect ratio input control can include a user definable horizontal value and a user definable vertical value. The image region can be a visible rectangular region containing a displayed image. An aspect ratio of the image region must equal a user defined aspect ratio established by the aspect ratio input control, whenever a ratio lock is engaged. When the ratio lock is disengaged, free form image region sizing can be permitted. The image region can be used to define a region within which an image manipulation operation adjusts the displayed image from a previous and different variant of the displayed image.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 illustrates conventional mechanisms for defining a region for which an image manipulation operation applies.

FIG. 2 shows a series of Graphical User Interfaces (GUIs) that illustrate user defined ratios for image regions in accordance with an embodiment of the inventive arrangements disclosed herein.

FIG. 3 is a flow chart of a method for using an on-screen pointer to adjust an image region that has a user defined aspect ratio in accordance with an embodiment of the inventive arrangement disclosed herein.

FIG. 4 is a flow chart of a method for quickly adjusting an aspect ratio of an image in accordance with an embodiment of the inventive arrangements disclosed herein.

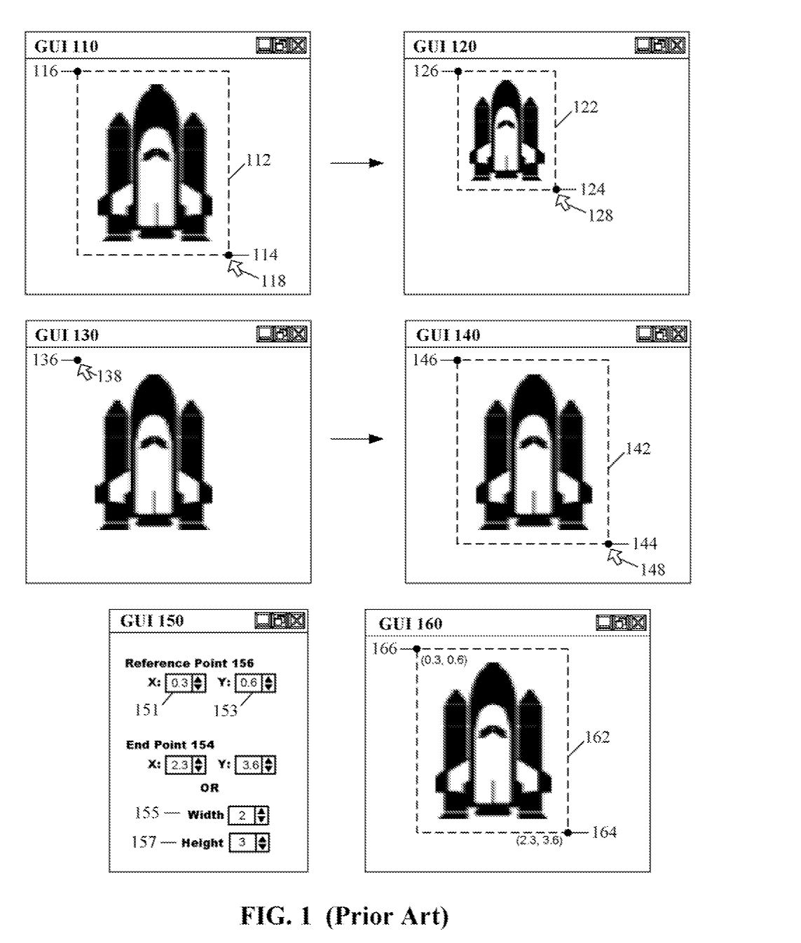

### DETAILED DESCRIPTION OF THE INVENTION

The present invention allows a user to define an aspect ratio for an image region. The image region is related to an image manipulation operation, such as resizing, clipping, cropping, and the like. The invention is primarily used in two different contexts. In one, the aspect ration is enforced when a user tries to draw or define an image region using an on-screen pointer, such as a mouse. In this context and when an associated aspect lock is enabled, a user will only be permitted to define a region that has the user defined aspect ratio. The invention can also enforce a user defined aspect ratio when a user uses a coordinate based method (illustrated by GUIs 150 and 160) for defining an image region.

In the second context, a user can select one or more preexisting image regions, which the user wants to change. After selecting these regions, a user can either define an aspect ratio for each region or can apply a previously established aspect ratio to each region. Either way, the user defined aspect ratio causes each preexisting image region to be dynamically and automatically resized in accordance with the user defined aspect ratio. An appropriate image manipulation operation, such as image resizing or clipping, can be automatically performed when each region is adjusted.

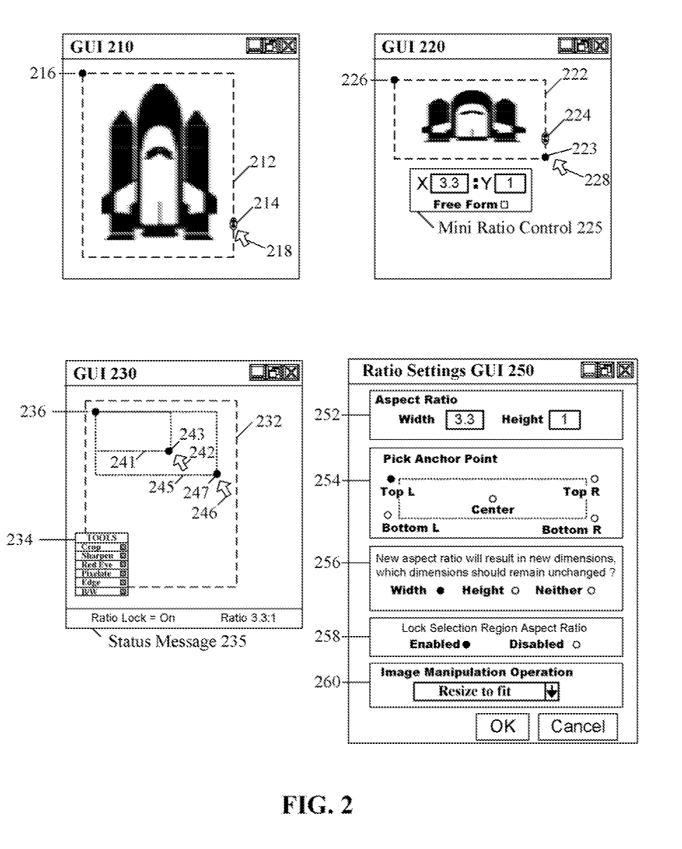

FIG. 2 shows a series of Graphical User Interfaces (GUIs) 210, 220, 230, and 250 that illustrate user defined ratios for image regions in accordance with an embodiment of the inventive arrangements disclosed herein. The arrangements, layout, and control elements for GUIs 210, 220, 230, and 250 have been provided for illustrative purposes only and derivatives and alternatives are contemplated herein and are to be considered within the scope of the present invention. For example, illustrated GUI selection mechanisms shown in FIG. 2 can be easily substituted with hot-key combinations, menu item selections, toolbar buttons, and the like, which are not explicitly shown.

GUI 210 shows an image contained within an image region 212. Region 212 represents an original region before a user defined aspect ration is applied. Image region 222 of GUI 220 represents an adjusted region corresponding to region 212. The adjusted region 222 can have the user defined aspect ratio. A quick adjustment option 214 or 224 can be used to automatically resize an image region 212 or 224 in accordance with a user defined ratio. Although shown as a visible icon, the quick adjustment option is not limited in this regard and can be implemented in any of a variety of other manners, such as through a hot-key combination.

In one embodiment, when option 214 is selected using on-screen pointer 218, a ratio settings dialog (or GUI) 250 can appear. GUI 250 can include an aspect ratio section 252, where a width and height can be established. An anchor section 254 can permit a user to set a top left point, a top right point, a bottom left point, a bottom right point, or a center point of a region as a reference point or anchor. As illustrated, the top left point (or reference point 216 or 226) has been selected as the anchor point. Section 256 acknowledges that enforcing an aspect ratio can result in a dimensional change to a region. A user can opt to maintain a width, a height, or neither of an original region 212. Opting for neither can result in changes to both a height and width of an original region 212. Section 258 permits a selection region aspect ratio lock to be enabled or disabled. Section 260 allows a user to select an image manipulation operation that is performed when the original region 212 is adjusted to create region 222. Selecting the OK button, applies the settings, which results in the automatic and dynamic creation of region 222.

In a different embodiment, a mini ratio control 225 can be initially presented when option 214 or 224 is selected. Control 225 allows a user to quickly define an aspect ratio for the associated region. Previously established settings not shown in control 225, such as those created using GUI 250, can remain in effect. A user can be allowed to click control 225 to automatically call up GUI 250.

Another way user defined aspect ratios can be utilized is when an original region 212 is redrawn using an on-screen pointer and a pointing device. For example, pointer 218 can select a bottom right handle of original region 212, after an aspect ratio of 3.3:1 has been established using control 225 or GUI 250. Once the handle is selected, the pointer 218 can be moved to dynamically resize the region 212. The resizing options, however, can be constrained to those rectangles having the 3.3:1 aspect ratio. Pointer 228 shows a final position of the on-screen pointer, which establishes endpoint 223 for adjusted image region 222.

Appreciably, endpoint 223 is not positioned in an exact position of the pointer 223, since that position would not result in a region 222 having an aspect ratio of 3.3:1. Instead, the nearest position to pointer 223, where the user defined aspect ratio is maintained is used. If a user wishes to redraw an image region 222 in a free form fashion without having the user defined aspect ratio imposed, an option to do so can be selected within control 225. A similar option exists in section 258 of GUI 250.

Often, image manipulation operations are applied to a portion of an image, such as when a portion of an image is cropped or when a special effect is applied to only one portion of an image. User defined aspect ratios can be enforced when defining any image region, even a sub region, which is shown by GUI 230. In GUI 230, a reference point 236 can be initially established within an image region 232. It is assumed that a user defined aspect ratio of 3.3 to 1 is currently in affect and that a ratio lock is being enforced for GUI 230, as shown by status message 235.

Thus, when a user moves a pointer 242 to position an endpoint 243 for region 241, the allowed areas of region 241 can be restrained by the user defined aspect ratio. For example, assuming that pointer 242 was moved horizontally to the right, the endpoint 243 would not move to the right in a corresponding fashion since that would violate the enforced aspect ratio.

If the pointer 242 were to be moved to the bottom right, as shown by pointer 246, a new position for an endpoint 247 can result, which in turn changes an area of a defined region 245. Once a region 241 or 245 has been defined, an image manipulation operation can be performed involving the region. For example, a control of an image manipulation tool 234 can be selected, and a corresponding operation can be performed. For example, when a crop control is selected, an active region 241 or 245 will be automatically sharpened.

The present invention teaches a means for selecting a region having an enforced user selected ratio. This selected region can be utilized irrespective of a type of image manipulation operation that is being performed against a region. Contemplated types of image manipulation operations include, but are not limited to, resizing, cropping, blurring, creating a negative of the image, rotating, gray scaling, adjusting contrast, adjusting brightness, adjusting hue, converting to sepia, morphing, edging, pixelating, reducing red-eye, and the like.

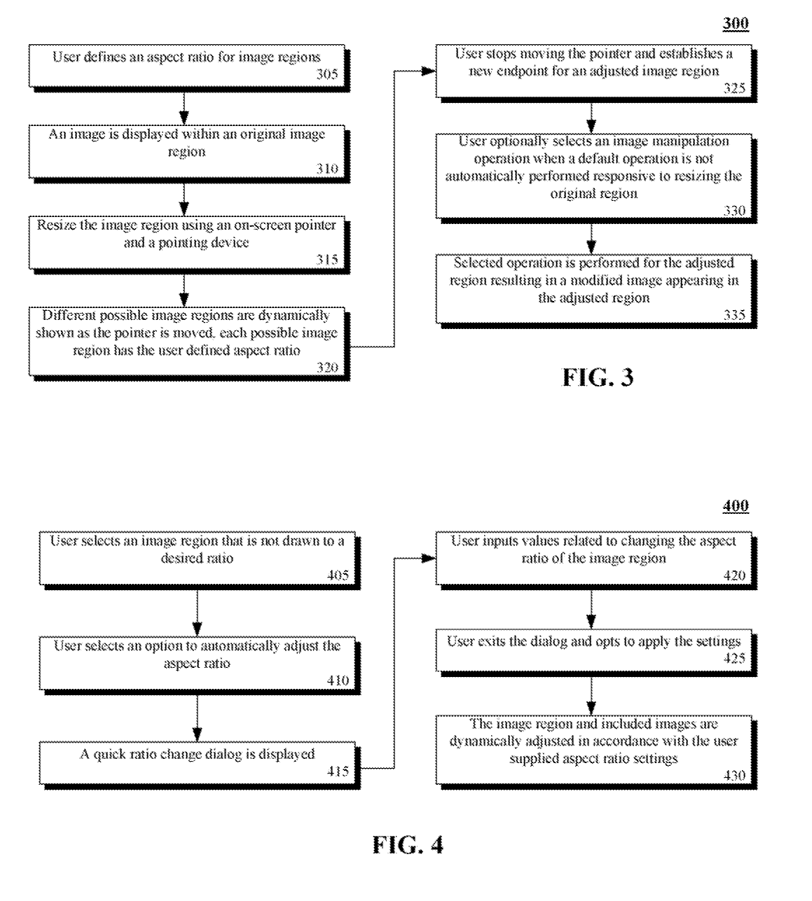

FIG. 3 is a flow chart of a method 300 for using an on-screen pointer to adjust an image region that has a user defined aspect ratio in accordance with an embodiment of the inventive arrangement disclosed herein. Method 300 can begin in step 305, where a user defines an aspect ratio for image regions. In step 310, an original image region that contains a displayed image can be presented within a GUI. In step 315, a pointing device, such as a mouse, can be used to resize the image region. In step 320, as an on-screen pointer is moved, different possible image regions can be dynamically shown. For example, each of these possible image regions can be shown as a semi-transparent area having a dotted outline, through which a portion of the underlying image can still be seen. Each possible image region can have the user defined aspect ratio.

In step 325, the user can stop moving the on-screen pointer, which results in a new endpoint being established based upon the pointer position. The new endpoint together with a reference point can define an adjusted image region. In step 330, a user can optionally select an image manipulation operation when a default operation is not automatically performed responsive to resizing the original region. For example, cropping operations and applying special effects typically require the adjusted region to be defined before an image operation is selected. Resizing operations, however, often are dynamically implemented as the original image area is resized. In step 335, a selected operation (or default operation when the operation is automatically performed) can be performed for the adjusted region. This can result in a modified image appearing in the adjusted image region.

FIG. 4 is a flow chart of a method 400 for quickly and automatically adjusting an aspect ratio of an image in accordance with an embodiment of the inventive arrangements disclosed herein. The method can begin in step 405, where a user can select an image region that does not have a desired aspect ration. In step 410, a user can select an option to automatically adjust the aspect ratio of the image. In step 415, a quick ratio change dialog, such as GUI 250, can be displayed. In step 420, the user can input values into the dialog. These values can include an aspect ratio, an anchor, a dimension to retain, and the like. In step 425, the user can exit the dialog, opting to apply the setting. In step 430, the originally selected region can be dynamically adjusted in accordance with the ratio and settings input into the quick-change dialog.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for adjusting an image displayed in a graphical user interface comprising:
identifying an original region that is a visible rectangular region containing a displayed digital image;
establishing a user defined aspect ratio using an aspect ratio input control;
changing an area of the original region that results in an adjusted region, said adjusted region automatically having the user defined aspect ratio; and
performing an image manipulation operation on the displayed digital image so that a manipulated version of the image is displayed within the adjusted region.

2. The method of claim 1, said changing step further comprising:
dynamically consisting of a mouse, a trackball, a touchpad a pointing stick, a touch screen, a manipulated by a pointing device.

3. The method of claim 2, wherein said pointing device is selected from a group of devices consisting of a mouse a trackball, a touchpad, a pointing stick, a touch screen, a joystick, a remote control, and a set of directional keys of a keypad.

4. The method of claim 2, further comprising:
providing a selectively enabled aspect lock, wherein when the aspect lock is enabled, the dynamically created adjusted region automatically has the user defined aspect ratio.

5. The method of claim 4, wherein when the aspect lock is disabled, the dynamically created adjusted region is a free form region not limited to the user defined aspect ratio.

6. The method of claim 1, further comprising:
selecting the original region;
activating a ratio adjustment action for the selected original region; and
said changing step automatically occurring responsive to the activating step.

7. The method of claim 6, wherein said original region is one of a plurality of image containing regions selected, and wherein said changing step automatically adjusts an area of each of the plurality of regions so that adjusted regions all have the user defined aspect ratio.

8. The method of claim 1, wherein the aspect ratio input control is a selectively visible control presented within a same window as the displayed image.

9. The method of claim 1, wherein the aspect ratio input control is contained within a dialog window that is a different window from that in which the displayed image is presented.

10. The method of claim 9, said dialog window further comprising an option to select an anchor point for the adjusted region, wherein selectable anchor point positions comprise a top left corner, a top right corner, a bottom left corner, and a bottom right corner.

11. The method of claim 9, said dialog window further comprising a selectable option for a dimension of the original region that is to remain unchanged when the automatically adjusted region is created, selectable dimensions including a horizontal dimension and a vertical dimension.

12. The method of claim 1, wherein the image manipulation operation is at least one of an image resizing operation, an image clipping operation, an image cropping operation, and an operation that adjusts a characteristic of the displayed image in accordance with a special effect.

13. A machine-readable storage having stored thereon, a computer program having a plurality of code sections, said code sections executable by a machine for causing the machine to perform the steps of:
identifying an original region that is a visible rectangular region containing a displayed digital image;
establishing a user defined aspect ratio using an aspect ratio input control;
changing an area of the original region that results in an adjusted region, said adjusted region automatically having the user defined aspect ratio; and
performing an image manipulation operation on the displayed digital image so that a manipulated version of the image is displayed within the adjusted region.

14. A graphical user interface (GUI) comprising:
an aspect ratio input control comprising a user definable horizontal value and a user definable vertical value; and
an image region configured as a visible rectangular region containing a displayed image, wherein an aspect ratio of the region must equal a user defined aspect ratio established by the aspect ratio input control, and wherein the image region defines a region within which an image manipulation operation adjusts the displayed image from a previous and different variant of the displayed image.

15. The interface of claim 14, wherein the image manipulation operation is at least one of an image resizing operation, an image clipping operation, an image cropping operation, and an operation that adjusts a characteristic of the displayed image in accordance with a special effect.

16. The interface of claim 14, wherein the image region comprises:
a reference point at one corner of the rectangular region; and
an endpoint at a diagonally opposed corner of the rectangular region from the reference point, wherein the endpoint is created using an on-screen pointer that is manipulated by a pointing device.

17. The interface of claim 14, wherein the image region results from an automatic adjustment of an original region that had an aspect ratio different from the user defined aspect ratio.

18. The interface of claim 17, wherein said image region comprises:
a reference point at one corner of the rectangular region positioned in a same place as a corresponding reference point of the original region; and
an endpoint at a diagonally opposed corner of the rectangular region from the reference point, said endpoint having one of an X and Y coordinate that has a same value as an equivalent coordinate of a corresponding endpoint of the original region, wherein the other coordinate has a different value as an equivalent coordinate of the corresponding endpoint.

19. The interface of claim 18, further comprising:
a user configurable control that determines which of the X and Y coordinate has the same value as the equivalent coordinate.

20. The interface of claim 18, further comprising:
an anchor selection option configured to permit a user to select which corner of the image region is to be used as the reference point.
